(19) United States
(12) Patent Application Publication
(10) Pub. No.: US 2004/0164619 A1
(43) Pub. Date: Aug. 26, 2004

(54) Connector module with embedded Power-Over-Ethernet functionality

(76) Inventors: Timothy J. Parker, Cupertino, CA (US); Nian Zhou, Cupertino, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/609,079

(22) Filed: Jun. 27, 2003

Related U.S. Application Data
(60) Provisional application No. 60/448,912, filed on Feb. 21, 2003.

(51) Int. Cl. H02J 1/00

(52) U.S. Cl. 307/80

(57) ABSTRACT

According to one embodiment of the invention, the connector module is an Ethernet jack module with embedded Power-over-Ethernet (PoE) functionality. Having a compatible pin configuration as an Ethernet jack module without PoE functionality, the connector module is adapted for placement on a circuit board employed within a switching device.

This application claims the benefit of priority on U.S. Provisional Application No. 60/448,912 filed Feb. 21, 2003.

### FIELD

Embodiments of the invention relate to the field of networking communications, in particular, to a connector module with embedded Power-Over-Ethernet (PoE) functionality.

### GENERAL BACKGROUND

Over the last decade, the popularity of Ethernet-based local area networks (LANs) has grown tremendously. In the 1980s, the Institute of Electrical and Electronic Engineers (IEEE) developed an Ethernet standard designated as IEEE 802.3, which has been universally adopted by the network industry. While Ethernet networks enable a variety of communication devices to communicate with each other, the location of these devices was substantially restricted to those areas in close proximity to an Alternating Current (AC) power outlet.

Recently, a revised standard entitled “Data Terminal Equipment (DTE) Power Via Media Dependent Interface” (IEEE 802.3af, 2001), was adopted. In accordance with the revised standard, power may be supplied from a switching device to an IEEE 802.3af compliant powered device when Power-over-Ethernet (PoE) circuitry is deployed within the switching device.

Currently, PoE circuitry is deployed within a switching device by installing a customized daughter card that supports discrete as well as integrated IEEE 802.3af features. The daughter card is connected to a motherboard of the switching device. Thus, multiple design layouts for the motherboard are needed; one layout to accommodate PoE circuitry and another layout to accommodate the absence of PoE circuitry. Multiple board designs are costly to maintain and unacceptable delays have been experienced when introducing a PoE version of a switching device following the initial switch release.

### BRIEF DESCRIPTION OF THE DRAWINGS The invention may best be understood by referring to the following description and accompanying drawings that are used to illustrate embodiments of the invention.

FIG. 1 is an exemplary embodiment of an Ethernet-based local area network (LAN) with a switching device operating in accordance with an embodiment of the invention.

FIG. 2 is an exemplary embodiment of the switching device of FIG. 1.

FIG. 3 is a first exemplary embodiment of an Ethernet jack module adapted with embedded Power-Over-Ethernet (PoE) functionality.

FIG. 4 is a second exemplary embodiment of an Ethernet jack module adapted with embedded Power-Over-Ethernet (PoE) functionality.

FIG. 5 is a third exemplary embodiment of an Ethernet jack module adapted with embedded Power-Over-Ethernet (PoE) functionality.

FIG. 6 is an exemplary embodiment of a magnetics employed within a first PoE functional block of the Ethernet jack module of FIGS. 3-5.

FIG. 7 is a fourth exemplary embodiment of an Ethernet jack module adapted with embedded PoE Functionality.

FIG. 8 is an exemplary embodiment of the connector module of FIG. 2.

FIG. 9 is an exemplary schematic of internal logic within the connector module of FIG. 8.

### DETAILED DESCRIPTION

Herein, certain embodiments of the invention relate to a connector module with embedded Power-Over-Ethernet (PoE) functionality. According to one embodiment of the invention, the connector module is an Ethernet jack module with embedded PoE functionality. Having a compatible pin configuration as an Ethernet jack module without PoE functionality, the connector module is adapted for placement on a circuit board employed within a switching device. The compatible pin configuration enables a uniform design across different product lines and product families.

Certain details are set forth below in order to provide a thorough understanding of various embodiments of the invention, albeit the invention may be practiced through many embodiments other than those illustrated. Well-known logic and operations are not set forth in detail in order to avoid unnecessarily obscuring this description.

In the following description, certain terminology is used to describe features of the invention. For example, a “component” pertains to hardware and/or software that perform a certain function. “Software” features executable code such as an application, an applet, a routine or even a series of instructions. The software may be stored in any computer storage medium such as a programmable electronic circuit, a semiconductor memory device (e.g., random access memory “RAM”, read-only memory “ROM”, flash memory, etc.), a floppy diskette, an optical disk such as a compact disk (CD) or digital versatile disc (DVD), a hard drive disk, or any type of link (defined below).

A “link” is generally defined as either a power supply medium or an information-carrying medium that establishes a communication pathway. Examples of such information-carrying medium include a physical medium such as one or more electrical wires, optical fibers, cables, bus traces, or similar materials. A “contact” is a pin, solder ball, lead line or other terminal connection.

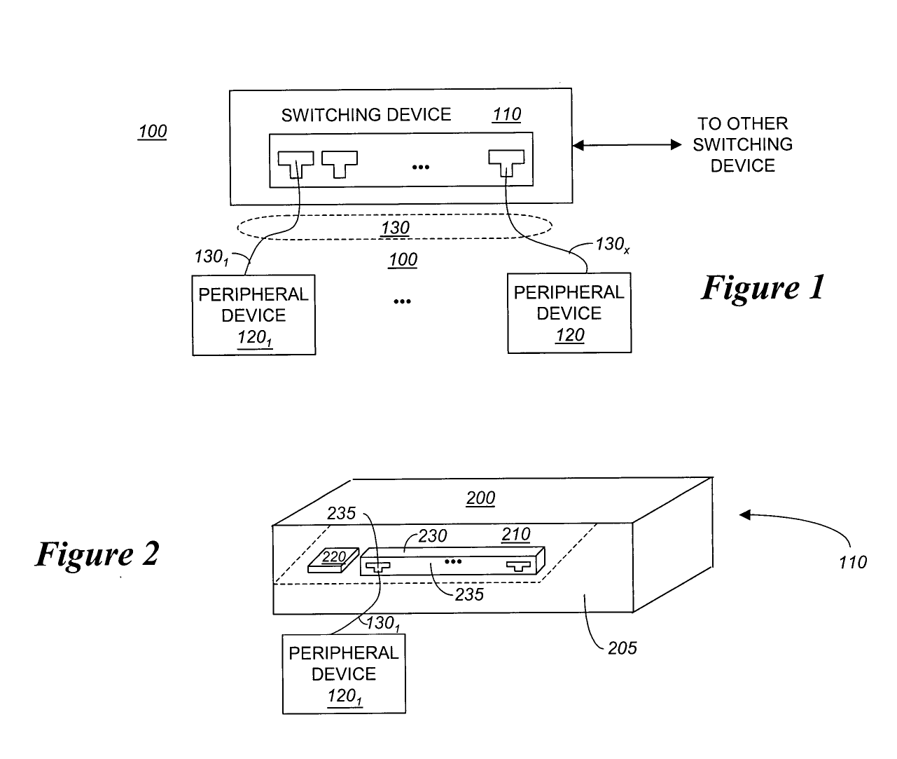

Referring to FIG. 1, an exemplary embodiment of a switching device 110 deployed within an Ethernet-based local area network (LAN) 100 is shown. Switching device 110 is a switch, which is configured to at least provide power to one or more peripheral devices 120₁-120ₓ (X≧1). Examples of the peripheral device(s) 120₁-120ₓ include, but are not limited to Internet Protocol (IP) phones, wireless access points (APs), network cameras, or any other type of IEEE 802.3 or IEEE 802.3af compliant powered device.

Switching device 110 is coupled to peripheral device(s) 120₁-120ₓ via links 130₁-130ₓ (generally referred to as “link 130”). For one embodiment, link 130 is a Category 5 (CAT-5) cable, which comprises four twisted pairs optionally housed in a protective sheath, one pair for each TX and RX. Of these twisted pairs, at least one twisted pair featuring a Transmit (TX) line and one Receive (RX) line is used for supplying power to each of peripheral device(s) 120₁-120ₓ. It is contemplated, however, that other types of cabling such as CAT-4 or CAT-3 may be used, provided at least one TX/RX pair can be used for supplying power to any one of peripheral device(s) 120₁-120ₓ.

Referring to FIG. 2, an exemplary embodiment of switching device 110 of FIG. 1 is shown. Switching device 110 comprises a chassis housing 200 made of a rigid material such as hardened plastic or metal. Chassis housing 200 protects components mounted on a circuit board 210 from damage caused by environmental conditions. Some of these components include a processor 220 and a connector module 230 in communication with each other.

As an illustrative embodiment of the invention, connector module 230 is a multi-port Ethernet jack module with embedded Power-Over-Ethernet (PoE), magnetics and light emitting diode (LED) components. Multiple jacks 235 are accessible from a side 205 of chassis housing 200 and adapted to supply power via an isolated voltage (e.g., approximately 48V DC at approximately 15.4 watts maximum per jack 235) to an IEEE 802.3af compliant device (e.g., peripheral device 120₁) over link 130₁. Ethernet jack module 230 may also support legacy powered devices that are pre-IEEE 802.3af standards and may require capacitive or other detection methods.

It is contemplated that some or all of jacks 235 of Ethernet jack module 230 may be RJ-45 jacks, an 8-pin jack featuring four (4) TX/RX pairs that can support 10 Base-T, 100 Base-T and 1000 Base-T Ethernet applications. Alternatively, some or all of jacks 235 may be RJ-21 jacks, a 50-pin jack featuring two (25) TX/RX pairs that can support 10 Base-T and 100 Base-T Ethernet applications. For any jack type implemented, at least one TX/RX pair needs to be reserved for power transmission.

It is appreciated that circuit board 210 can be designed with a single uniform layout, provided the count and placement of contacts of Ethernet jack module 230 with embedded PoE functionality is compatible with an Ethernet jack module without PoE functionality. Alternatively, if all Ethernet jack modules are configured with embedded PoE functionality, updating from non-PoE to PoE functionality may be accomplished by simply connecting a 48V DC power supply to Ethernet jack module 230. Thus, no redesign of the circuit board layout is necessary. Circuit board 210 (e.g., motherboard) may have stuffing options for PoE or non-PoE application, since additional components may be needed on circuit board 210 for PoE application.

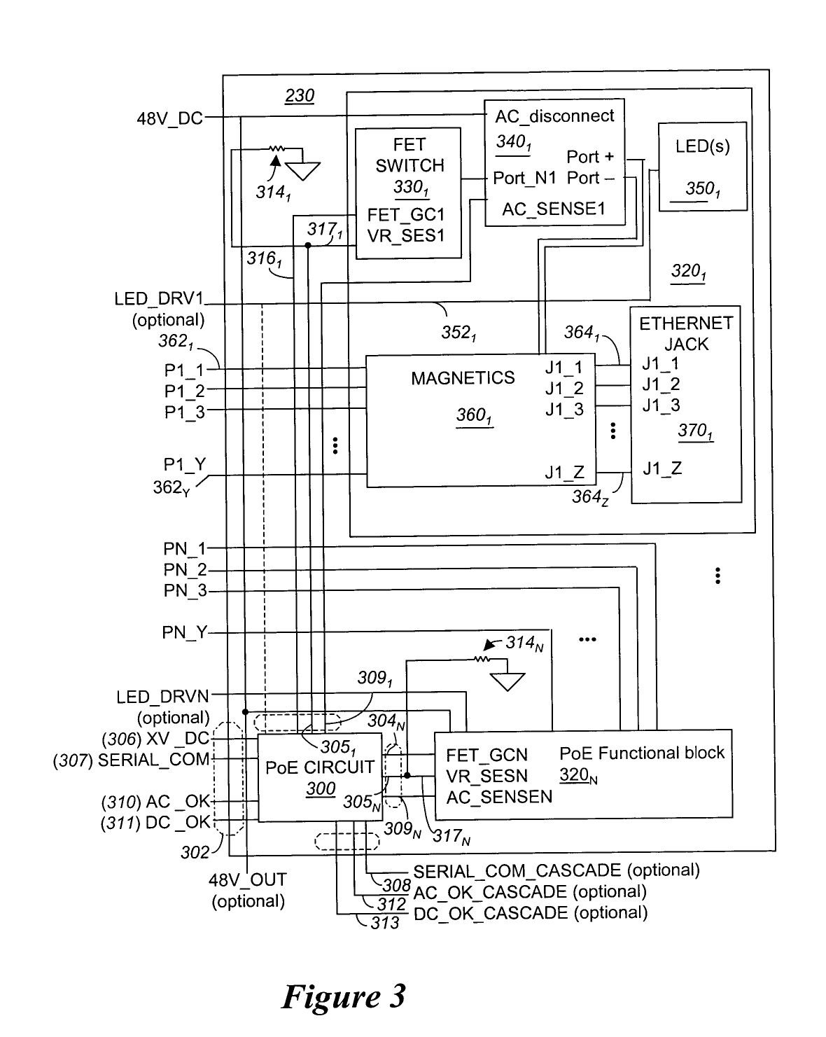

Referring now to FIG. 3, a first exemplary embodiment of Ethernet jack module 230 with embedded Power-Over-Ethernet (PoE) functionality is shown. Ethernet jack module 230 with embedded PoE capability can be as simple as embedding a power field-effect transistor (FET) on a per port basis to a complete power managed microprocessor controlled PoE solution required for 802.3af compliance.

Herein, for this embodiment, module 230 comprises a PoE circuit 300 that is responsible for controlling power transfer operations performed by one or more PoE functional blocks 320₁-320_{N}(N≧1). Each PoE functional block comprises a plurality of components such as a field-effect transistor (FET) switch, alternating current (AC) disconnect (detection), one or more light emitting diodes (LEDs), magnetics and an Ethernet jack. Using a first PoE functional block 320₁, for illustrative purposes, block 320₁ comprises a field-effect transistor (FET) switch 330₁, an alternating current (AC) disconnect 340₁, one or more light emitting diodes (LEDs) 350₁, magnetics 360, and an Ethernet jack 3701.

PoE circuit 300 operates as a power management agent in Ethernet jack module 230 to perform functions specified in the IEEE 802.3af standard with the aid of a built-in or external microcontroller. Some of these functions include, but are not limited or restricted to detection and classification of IEEE 802.3af compliant powered devices, initialization and power management, power control and power status collection, and communication between other PoE circuits and/or an external controller.

As shown, for this embodiment, PoE circuit 300 comprises a communication interface 302 that features a plurality of contacts, including but not limited or restricted to the following:

1) gate control (FET_GC1 . . . FET_GCN) 304₁-304_{N}

2) voltage sense (VR-SES1 . . . VR-SESN) 305₁-305_{N}

3) input voltage (XV_DC) 306

4) serial communication (SERIAL_COM) 307

5) cascade serial communication (SERIAL_COM_CASCADE) 308

6) AC disconnect sense (AC_SENSE) 309₁-309_{N}

7) AC power supply indication (AC_OK) 310

8) DC power supply indication (DC_OK) 311

9) AC power supply indication cascade (AC_OK_CASCADE) 312

10) DC power supply indication cascade (DC_OK_CASCADE) 313

For clarity sake, the functionality associated with contacts pertaining to first PoE functional block 320, is described because the same functions are applicable between contacts pertaining to other PoE functional blocks.

FET Gate Control contact 304, (FET_GC1) is a contact (output) for PoE circuit 300 that is used to control FET switch 330₁ to determine the amount of allowed current flowing into a peripheral device coupled to Ethernet jack 370₁ (e.g., IEEE 802.3af compliant powered device 120ᵢ of FIG. 1). Although not shown in detail, it is appreciated that PoE circuit 300 may be implemented with “N” FET Gate Control contacts, corresponding to the number of PoE functional blocks.

More specifically, FET_GC1 304₁ is selectively coupled to PoE functional block 320₁ through gate control link 316₁. This enables PoE circuit 300 to control FET switch 330₁, being one or more FETs collectively operating as a switch. For instance, if FET switch 330₁ is turned OFF, current flow over voltage return path 317₁ is interrupted. This causes no power to be transferred over the corresponding Ethernet jack 3701. The same control operations may be performed via any of the FET_GCi contacts 304ᵢ (where 1≦i≦N).

Impedance element 314₁ is coupled to voltage return path 317₁ and is used by PoE circuit 300 to adjust the amount of power supplied by PoE functional blocks 320₁. This is accomplished during the classification scheme in which the PoE circuit 300 provides a certain amount of current and measures the drop in order to determine a maximum available power threshold. Herein, as shown, each impedance element 314₁, . . . , 314_{N} is a sense resistor terminated at one end by ground (48V common), although it is contemplated that other types of impedances may be used.

VR_SES1 305₁, is a voltage sensing contact (input) for PoE functional block 320₁. This allows internal circuits within PoE circuit 300 to measure (sense) the voltage on impedance element 314₁ (e.g., sense resistor R1) for detection of a powered device coupled to Ethernet jack 370₁ and for classification (prioritizing) of Ethernet jacks 370₁-370_{N}. The number of voltage sensing contacts is normally equivalent to “N”, namely the number of PoE functional blocks.

XV_DC 306 is a contact (input) to receive a predetermined DC voltage from a DC power supply. This DC voltage is used to supply power to the internal PoE circuit 300 and associated circuits within Ethernet jack module 230. Although not shown, the DC power supply may be situated within chassis housing 200, mounted on circuit board 210 of FIG. 2, or situated externally from chassis housing 200.

SERIAL_COM 307 is a serial communication interface for the PoE chip to communicate with the microcontroller or HOST controller on the circuit board. SERIAL_COM 307 receives control information for managing power transmissions by PoE functional blocks 320₁-320_{N} and transmits status of the controlled port to the controller on the circuit board. For instance, the serial control information may include initialization signal that indicates a Power-On condition by the switching device. This may cause PoE circuit 300 to initially activate all or none of PoE functional blocks 320₁-320_{N}. In addition, the serial control information may be status information as to priority levels associated with each Ethernet jack so that a reduction in supply power will cause power to be discontinued to those jacks having lesser priority than others.

It is contemplated that SERIAL_COM 307 may be adapted with multiple contacts. Examples of different types of serial communication interfaces include, but are not limited to I²C, Universal Asynchronous Receiver Transmitter (UART) or some other serial communication interface.

SERIAL_COM_CASCADE 308 is a serial interface that can be coupled to a SERIAL_COM interface of a neighboring Ethernet jack module to form a cascaded serial communication link. Similarly, SERIAL_COM_CASCADE 308 may be adapted in accordance with I²C or UART configurations.

AC_SENSE 309, is a contact (input) to receive a sense signal from AC_disconnect circuitry 340₁ of PoE functional block 320₁. Activation of AC_SENSE contact 309₁ indicates that a link has been disconnected from Ethernet jack 370₁.

AC_OK 310 is a contact (input) to receive a logic signal from an AC/DC power supply (AC to DC converter). When placed in a predetermined logic state (e.g., “0” or “1”), AC_OK 310 indicates the AC power supply is working properly.

DC_OK 311 is a contact (input) to receive a logic signal from a DC/DC power supply (DC to DC converter). When placed in a predetermined logic state (e.g., “0” or “1”), DC_OK 311 indicates the DC power supply is working properly.

AC_OK_CASCADE 312 is an optional contact (output) that, when placed in a predetermined logic state, indicates to the neighboring cascaded Ethernet jack module that the AC power supply is working properly.

DC_OK_CASCADE 313 is an optional contact (output) that, when placed in a predetermined logic state, indicates to the neighboring Ethernet jack module that the DC power supply is working properly.

As shown, it is contemplated that Ethernet jack module 230 may include a 48V_OUT contact (output) to enable a neighboring, cascaded Ethernet jack module that may be coupled to a 48V_DC contact (input) to receive 48V DC instead of directly coupling to the 48V power supply. This feature would reduce trace routing and provide a less complex circuit board.

Referring still to FIG. 3, each FET switch 330₁-330_{N} is located on its corresponding voltage return path 317₁-317_{N}. The amount of current that flows through a FET switch from source to drain, for example FET switch 330₁, is controlled by PoE Circuit 300 through FET_GC1 contact 304₁. Although not shown, for this embodiment, a drain terminal of FET switch 330, is connected to external sense resistor R1 314₁ and VR_SES1 contact 305, of PoE circuit 300. The source of FET switch ³³⁰₁ is coupled to AC_disconnect 340₁.

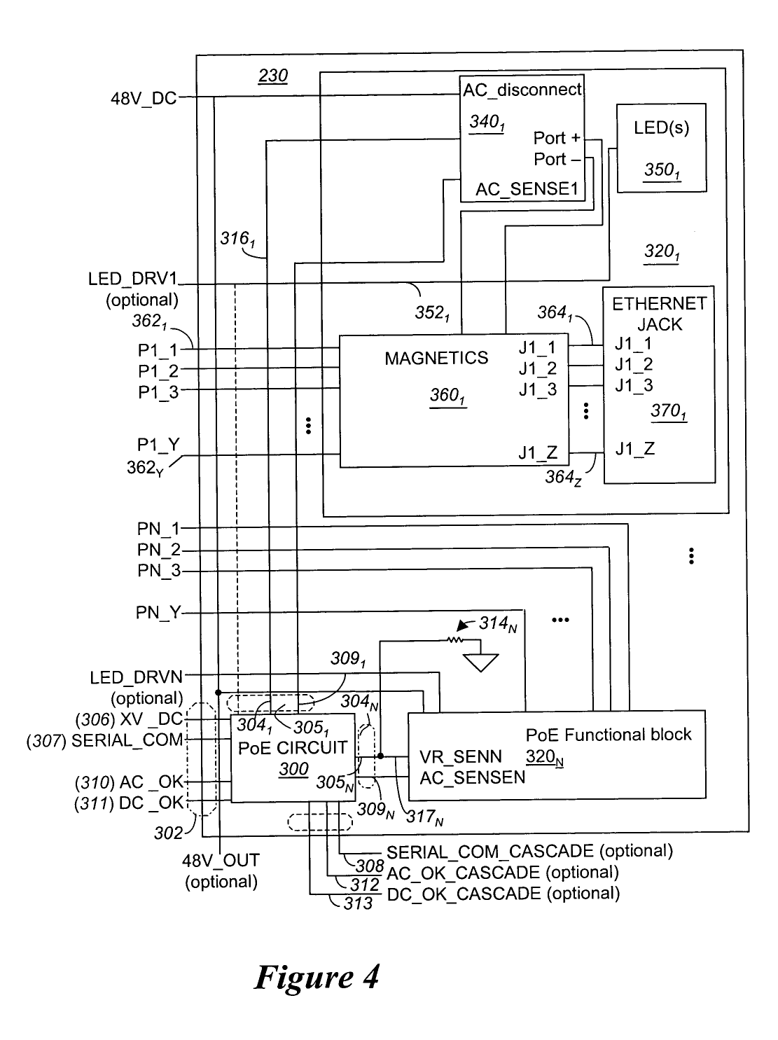

It is contemplated, however, that one or more FET switches 330₁-330_{N} may be integrated into PoE circuit 300 in lieu of having these FET switches externally located. The alternative embodiment is shown in FIG. 4.

Referring back to FIG. 3, each AC disconnect 340₁, . . . , 340_{N} is adapted to detect whether or not a link is removed from its corresponding Ethernet jack 370₁, . . . , 370_{N}, respectively. Upon detection of a link being removed from its corresponding Ethernet jack 370₁, . . . , or 370_{N}, AC disconnect 340₁, . . . , or 340_{N} discontinues supplying power thereto. For example, if a link is removed from Ethernet jack 370₁, AC disconnect 340₁ discontinues supplying power to Ethernet jack 370₁ and provides and indication that may alter the state of its corresponding LED 350₁.

A 48V DC supply voltage is also connected to AC disconnect 340₁, which will go through a one direction conducting device and arrive at an output contact (Port+) 342₁. AC disconnect 340₁ generates an AC signal and provides this signal to a voltage divider positioned as part of magnetics 360₁ across Port+342₁ and input contact (Port−) 344₁. Port-344₁ operates as a 48V return.

The AC signal will not go back to 48V power source. Instead, the AC signal will be supercomposed onto 48V DC voltage and sent to peripheral device 120, coupled over a link to Ethernet jack 3701. The amplitude of the voltage on a center tap of the divider will change significantly when the cable is disconnected from the jack. And this voltage change will be detected by PoE circuit 300 through AC_SENSE contact 3091.

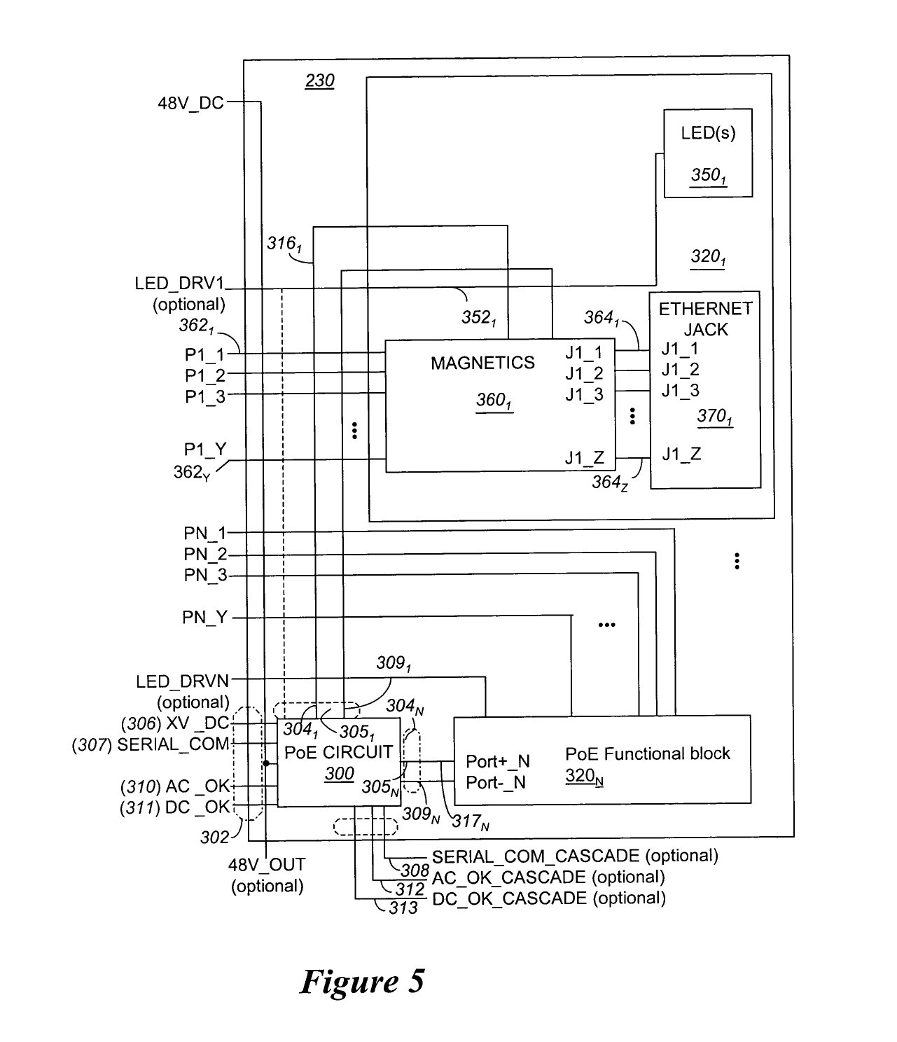

As shown in FIG. 5, one or more of AC disconnect 340₁-340_{N} may be alternatively implemented within PoE circuit 300 as a built-in AC disconnect circuit.

Referring back to FIG. 3, each LED 350₁, . . . , and 350_{N} is used to identify (1) whether a peripheral device requiring power is connected to the corresponding Ethernet jack 3701, . . . , and 370_{N}, (2) whether there is any activity such as data transfer between the switch and the peripheral device, and (3) if a fault is detected for the connection. For instance, a peripheral device 120, of FIG. 1 is coupled to Ethernet jack 370₁ via a link in compliance with IEEE 802.3af. If peripheral device 120₁ is not adapted to receive power over Ethernet, LED 350₁ is set to a first state (e.g., a first color or flashing interval, etc.). However, if peripheral device 120₁ is adapted to receive power over Ethernet, LED 350₁ is set to a second state that visually differs from the first state.

In addition, if a fault in the connection is detected such as a shorted line for example, LED 350, is set to a third state that visually differs from either the first or second states.

As shown in FIG. 3, each LED (e.g., LED 3501) features an LED drive link (LED_DRV) 352, that drives LED 350, to its given state. As shown, LED 350, is driven by circuitry on circuit board 210 of FIG. 2. However, as an alternative, it is contemplated that LED drive link 352₁ may be coupled to PoE circuit 300 as illustrated by a dashed control line 354₁.

Magnetics 360, comprises a transformer and noise rejecting coil filter on the ferrite core. One function of magnetics 360, is to bridge a physical layer chip (not shown) and its corresponding Ethernet jack 370₁ so that the impedance can be matched and the signal ground and chassis ground can be isolated. Another function of magnetics 360₁ is to reject common mode noise between Ethernet jack 370₁ and the physical layer chip. Yet another function of magnetics 360₁ is to attenuate unwanted frequency and isolate the DC path, namely block DC voltage/current on the physical chip side to prevent DC current from flowing into the link via the Ethernet jack 370₁.

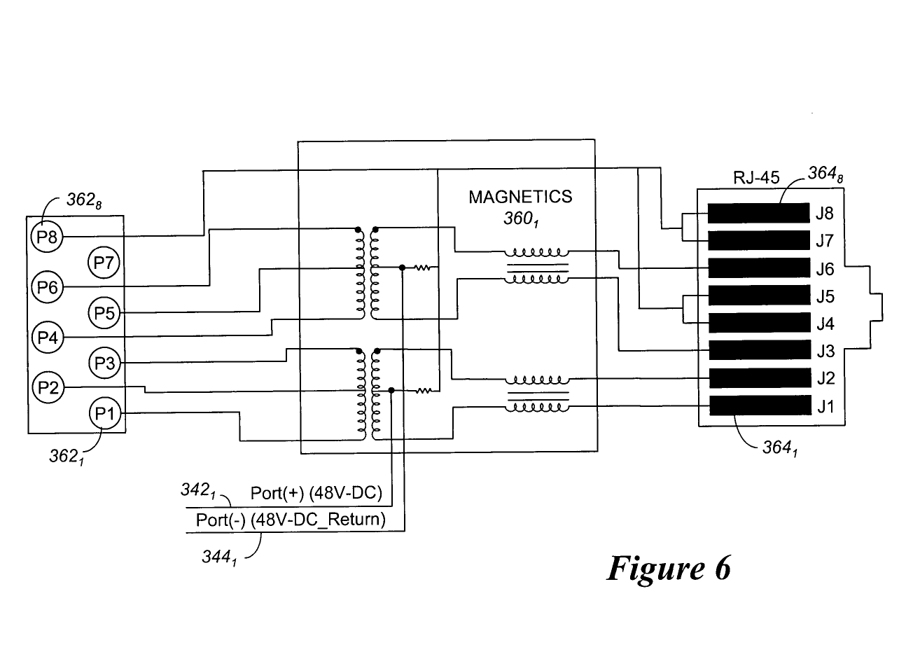

More specifically, as shown in FIGS. 3 and 6, the center taps (Ethernet jack side) of transmit and receive transformers 366 and 367 are tied to Port+342₁ and Port−344₁ of AC disconnect 340₁, respectively. IEEE 802.3af standard has specified how to make connections in different configuration. The number of contacts may vary with different jacks. Contacts P1_1 through P1_Y 362₁-362_{y} (referenced as P1-P8 362₁-362ₛ of FIG. 6) are configured for coupling to the physical layer chip while contacts J1_1 through J1_Z 364₁-364_{z} (referenced as J1-J8 364₁-364ₛ of FIG. 6) are tied to Ethernet Jack 370₁. For this illustrative embodiment, the number of “Y” contacts 362₁-362ₛ is equivalent to the number of “Z” Ethernet jack contacts 364₁-364ₛ, although the number of these contacts may differ.

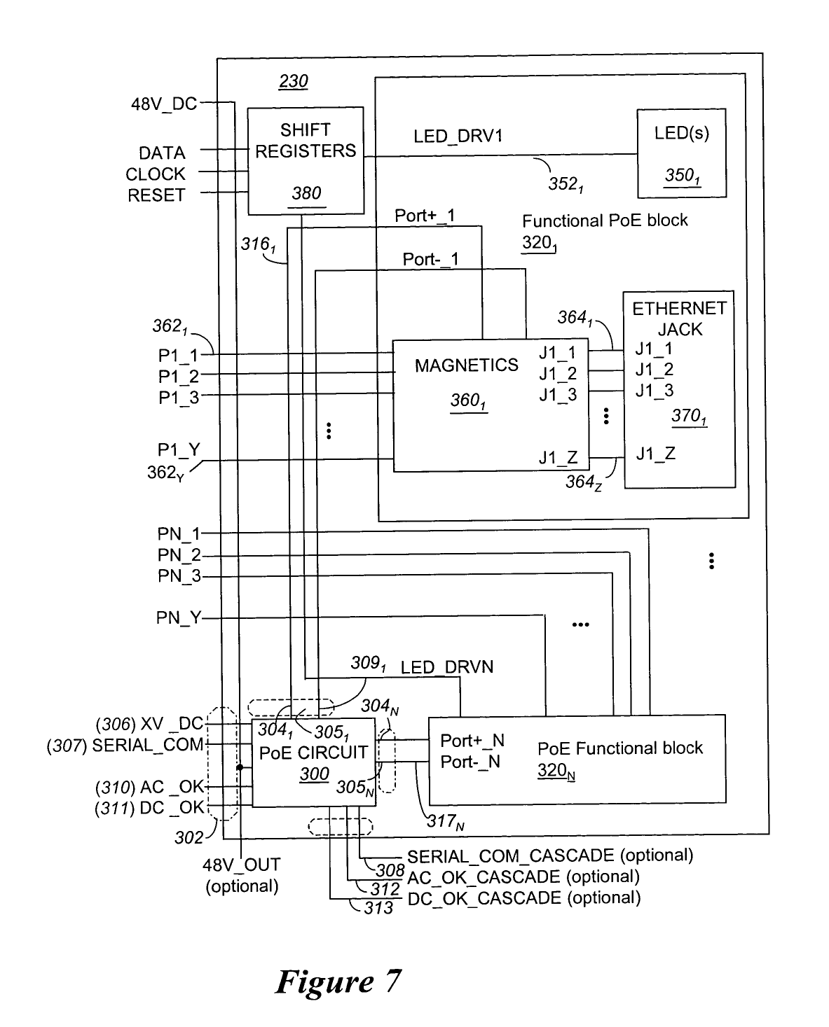

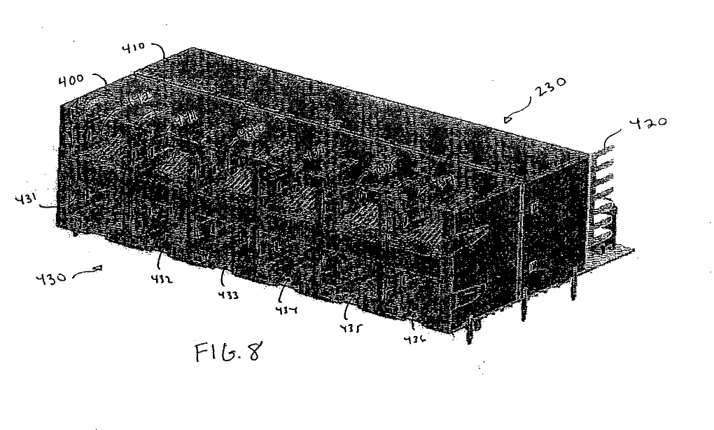

Referring now to FIG. 7, a fourth exemplary embodiment of an Ethernet jack module adapted with embedded PoE functionality is shown. One or more shift registers 380 are employed within connector module 230. Shift register(s) 380 are placed within connector module 230 in order to reduce pin count where the number “N” of functional PoE blocks exceeds three, instead of separate LED drive signals (LED_DRV1 . . . LED_DRVN) as shown in FIGS. 3-5. The LED control signals on shift registers 380 such as data (data out), clock and reset can be cascaded too.

Based on data, clock and reset input signals, shift register(s) 380 provide an output that is used to drive each LED to its given state. For instance, in one embodiment of the invention, shift registers 380 output a dedicated signal over a first LED drive link (LED_DRV1) 352₁ which drives LED 350₁ to its given state. Additionally, shift registers 380 output other dedicated LED drive signals to LEDs associated with corresponding functional PoE blocks (up to functional PoE block 320_{N}).

Even where internal voltages utilized by connector module 230 are isolated, shift register(s) 380 do not require any opto-couplers because the register(s) is (are) referenced to the digital domain.

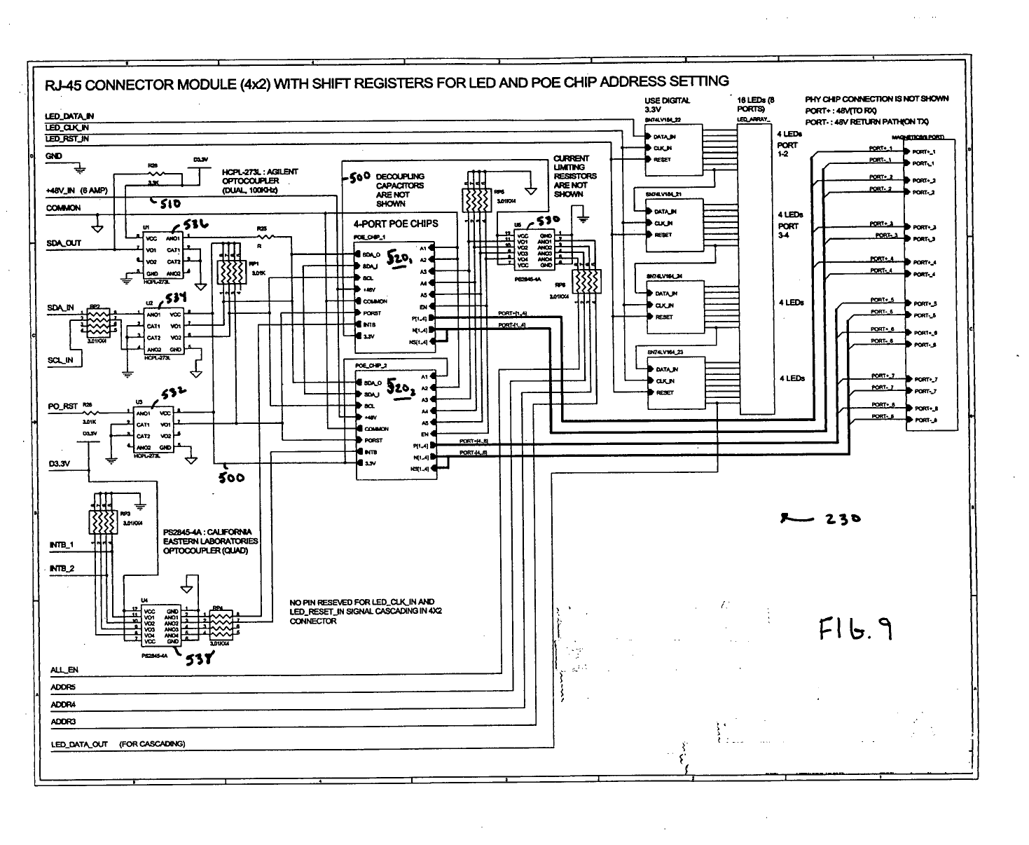

Referring to FIG. 8, an exemplary embodiment of a perspective layout of connector module 230 of FIG. 2 is shown. Adapted for mounting on a circuit board such as a motherboard for example, connector module 230 comprises a first portion 400, a second portion 410 and a thermal dissipation element 420 positioned adjacent to second portion 410. An example of a type of thermal dissipation element 420 includes, but is not limited or restricted to a heat sink.

In one embodiment of the invention, a plurality of power connectors 430 form first portion 400. Each power connector 431-442 is adapted to receive an isolated supply voltage from a power supply (not shown) over a link. For one embodiment of the invention, the isolated supply voltage is approximately 48 volts (V).

Herein, as further shown in FIG. 9, connector module 230 is completely and independently isolated, namely no motherboard isolation is required. Such isolation is achieved by the following: (1) using surface mounted independent power connector for 48V power and common; (2) internally regulating isolated internal voltage 500, which are derived from isolated incoming 48V power supply 510 and supplied to two PoE functional blocks, and to opto-couplers 530, 532, 534, 536 and 538; and (3) using opto-couplers to isolate serial communication interface, address setting interface, reset and interrupt request signal lines of the PoE functional blocks.

For one embodiment of the invention, the internal supply voltage for a first 4-port PoE chip 520₁(e.g., part of PoE functional block 320, of FIG. 3-5 and 7) is approximately 3.3V and is internally regulated within connector module 230 by PoE chip 520₁ itself (there is a 48V to 3.3V DC/DC converter inside). Opto-couplers 530, 532, 534, 536 and 538 employed within connector module 230 are used to isolate control signals routed to PoE chips 520₁-520₂, because the PoE chip control signals are refrenced to 48V common internally which has to be isolated from digital ground on the circuit board.

Thus, no added motherboard layers are required to support PoE when connector module 230 is mounted thereon. As a result, the design of the PoE solution is simplified and the cost for deployment is substantially reduced.

While the invention has been described in terms of several embodiments, the invention should not limited to only those embodiments described, but can be practiced with modification and alteration within the spirit and scope of the invention. For instance, the PoE logic may be implemented at the powered device (e.g., peripheral device) instead of within the switching device.

What is claimed is:

1. A connector module comprising:
at least one jack adapted for coupling to a link; and
circuitry coupled to the jack, the circuitry configured to perform Power-over-Ethernet (PoE) operations by supplying power through the jack.

2. The connector module of claim 1 being an Ethernet jack module with embedded PoE functionality and the jack being an Ethernet jack.

3. The connector module of claim 1, wherein the Ethernet jack is either an RJ-45 jack or an RJ-21 jack.

4. The connector module of claim 1, wherein the circuitry comprises:
a FET switch;
an AC disconnect component coupled to the FET switch;
magnetics coupled to the AC disconnect component; and
a PoE circuit coupled to the FET switch, the PoE circuit to vary the amount of power supplied over the jack by adjusting current supplied to the FET switch.

5. The connector module of claim 4, wherein the PoE circuit is coupled to the AC disconnect component in order to discontinue power supplied to the jack when the link is disconnected from the jack.

6. The connector module of claim 4, wherein the AC disconnect is coupled to (i) center taps of magnetics and (ii) a power supply to receive a direct current (DC) supply voltage therefrom.

7. The connector module of claim 4, wherein the circuitry further comprises one or more light emitting diodes being in a first state when the link is disconnected from the jack and in a second state when the link is coupled to the jack.

8. The connector module of claim 5, wherein the one or more light emitting diodes of the circuitry being in a third state upon detecting a fault in an electrical connection established by the link when the link is coupled to the jack.

9. The connector module of claim 4, wherein the one or more light emitting diodes of the circuitry being in a blinking state during communications between the connector module and a peripheral device and in a no light state when the communications have stopped.

10. The connector module of claim 4, wherein the magnetics comprises a pair of transformers each having a center tap coupled to the AC disconnect.

11. The connector module of claim 1 being implemented on a circuit board within a switching device including a housing substantially enclosing the connector module with at least the jack accessible for coupling to the link.

12. The connector module of claim 2 being adapted within a switching device to receive direct current (DC) voltage from an externally located power supply and, under control of the circuitry embedded within the connector module, to transmit power to IEEE 802.3af compliant powered device coupled to the at least one Ethernet jack of the connector module.

13. The connector module of claim 11, wherein the circuitry further comprises at least one opto-coupler to isolate a common voltage and digital ground for one or more control signals supported by the circuitry.

14. The connector module of claim 1, wherein the circuitry comprises a plurality of PoE functional blocks each including a light emitting diode, an Ethernet jack and magnetics; and
at least one shift register coupled to the light emitting diodes for each of the PoE functional blocks, the at least one shift register to drive the light emitting diodes.

15. A connector module comprising:
a plurality of Ethernet jacks each adapted for coupling to a link; and
circuitry, coupled to the plurality of Ethernet jacks, to perform Power-over-Ethernet (PoE) operations by supplying power through each of the plurality of Ethernet jacks, the circuitry comprises magnetics and a PoE circuit, the PoE circuit to vary the amount of power supplied over any of the plurality of Ethernet jacks.

16. The connector module of claim 15, wherein the circuitry further comprises a plurality of light emitting diodes each corresponding to one of the plurality of Ethernet jacks, each light emitting diode operating in a first state when the link is disconnected from its corresponding Ethernet jack and in a second state when the link is coupled to its corresponding Ethernet jack.

17. The connector module of claim 15, wherein the circuitry further comprises an AC disconnect component coupled to the PoE circuit and the magnetics, the AC disconnect to discontinue a supply of power to one of the plurality of Ethernet jacks when the jack is decoupled from a link and to provide an indication that may alter a state of a light emitting diode corresponding to the one of the plurality of Ethernet jacks.

18. The connector module of claim 15, wherein the PoE circuit of the circuitry is coupled to the magnetics.

19. A Power-Over-Ethernet (PoE) circuit adapted for controlling power supplied over a plurality of Ethernet jacks, the PoE circuit comprising:
a plurality of voltage sensing contacts each to detect whether a powered device is coupled to an Ethernet jack of the plurality of Ethernet jacks corresponding to the voltage sensing contact and to prioritize the plurality of Ethernet jacks;
a first contact to receive a predetermined direct current (DC) voltage from a power supply;
a first serial interface to receive control information for managing power transmissions by the PoE circuit; and
a second serial interface adapted for coupling to a first serial interface of a neighboring PoE circuit.

20. The PoE circuit of claim 19, further comprising a second contact to receive a signal from an alternating current (AC) disconnect.

21. The PoE circuit of claim 19, further comprising a plurality of contacts each adapted for coupling to one of a plurality of switches for controlling an amount of current flowing into a powered device coupled to one of the plurality of Ethernet jacks, an interruption of current flow into the powered device causes no power to be transferred to the powered device from the one of the plurality of Ethernet jacks.

22. The PoE circuit of claim 19, further comprising a second contact to receive a logic signal from the power supply to indicate whether the power supply is working properly.

23. The PoE circuit of claim 19, further comprising a second contact that, when placed in a predetermined logic state, indicates to the neighboring PoE circuit that the power supply is working properly.

24. A method comprising:
receiving an isolated supply voltage by a connector module that comprises a Power-over-Ethernet (PoE) circuit and a plurality of jacks;
internally regulating an isolated internal voltage being less than the isolated supply voltage within the connector module;
performing PoE operations within the connector module to manage power transmissions by the PoE circuit; and
supplying power through at least one of the plurality of jacks to a neighboring connector module.
